(19) United States
(12) Patent Application Publication
(10) Pub. No.: US 2016/0077795 A1
(43) Pub. Date: Mar. 17, 2016

(54) DISPLAY APPARATUS AND METHOD OF CONTROLLING THEREOF

(71) Applicant: Samsung Electronics Co., Ltd., Suwon-si (KR)

(72) Inventors: Sang-ok CHA, Suwon-si (KR); Min-kyoung YOON, Seoul (KR); Young-jun YOON, Seoul (KR); Joo-yeon CHO, Seoul (KR)

(21) Appl. No.: 14/848,828

(22) Filed: Sep. 9, 2015

(30) Foreign Application Priority Data
Sep. 17, 2014 (KR) 10-2014-0123558

(51) Int. Cl. G06F 3/16; G06F 3/041; G06F 3/0488; G06F 3/0481; G06F 3/0484

(52) U.S. Cl. CPC G06F 3/167; G06F 3/04817; G06F 3/04842; G06F 3/04886; G06F 3/0416

(57) ABSTRACT

A display apparatus and a method of controlling the display apparatus are provided. The method includes analyzing a display item displayed on a display screen, outputting audio corresponding to the analyzed display item, and in response to the audio being output, displaying a user interface (UI), which includes at least one icon for controlling a display item corresponding to the output audio, in an area of the display screen.

### CROSS-REFERENCE TO RELATED APPLICATION(S)

This application claims the benefit under 35 U.S.C. §119(a) of a Korean patent application filed on Sep. 17, 2014 in the Korean Intellectual Property Office and assigned Serial number 10-2014-0123558, the entire disclosure of which is hereby incorporated by reference.

### TECHNICAL FIELD

The present disclosure relates to a display apparatus and a method of controlling thereof. More particularly, the present disclosure relates to a display apparatus that displays a function performable in a screen element output as audio and a method of controlling thereof.

### BACKGROUND

Recent developments of a related technology have provided a function of reading screen elements displayed on a display apparatus or the like. When a function of analyzing such display elements and outputting the display elements as audio is performed, a task that may be performed through elements output as audio is frequently missed.

If a display element that is currently output as audio is a controller performing a particular function or a link to an external website, there is a need for an interaction of a user to search for and re-input the corresponding display element. Therefore, the user has a problem of searching for a particular display element on a screen.

Also, there occurs a problem that information is not effectively provided to users, who are mainly using a function of reading displayed screen elements and have poor eye-sight, in a particular area of a display screen.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide recommending and executing of a task performable through a corresponding screen element when a displayed screen element is output based on a voice.

In accordance with an aspect of the present disclosure, a method of controlling a display apparatus is provided. The method includes analyzing a display item displayed on a display screen, outputting audio corresponding to the analyzed display item, and in response to the audio being output, displaying a user interface (UI), which includes at least one icon for controlling a display item corresponding to the output audio, in an area of the display screen.

In accordance with another aspect of the present disclosure, a display apparatus is provided. The display apparatus includes a display, an audio outputter configured to output an audio signal, and a controller configured to control the audio outputter to analyze a display item displayed on a display screen of the display, to control the audio outputter to output audio corresponding to the analyzed display item, and to control the display to, in response to the audio being output, display a UI including at least one icon for controlling a display item corresponding to the output audio in an area of the display screen.

According to various embodiments of the present disclosure as described above, a user may be informed of a task performable on a display apparatus, and an icon mapped on the task may be provided to a UI. Therefore, an inconvenience of the user who searches for and re-inputs a corresponding screen element may be reduced.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic block diagram illustrating a structure of a display apparatus according to an embodiment of the present disclosure;

FIG. 2 is a block diagram illustrating a detailed structure of a display apparatus according to an embodiment of the present disclosure;

FIG. 3 is a view illustrating a user interface (UI) including at least one icon for controlling a display item according to an embodiment of the present disclosure;

FIG. 4 is a view illustrating a display item that is a music item according to an embodiment of the present disclosure;

FIGS. 5A and 5B are views illustrating a display item that is a scroll bar item according to an embodiment of the present disclosure;

FIG. 6 is a view illustrating a display item that is a slide bar item according to an embodiment of the present disclosure;

FIGS. 7A and 7B are views illustrating a display item that is a text item including a text according to various embodiments of the present disclosure;

FIGS. 8A and 8B are views illustrating a display item that is a hyperlink item according to various embodiments of the present disclosure;

FIGS. 9A, 9B, 9C, and 9D are views illustrating a display item that is a text input item according to various embodiments of the present disclosure;

FIGS. 10A and 10B are views illustrating a task that is executed through an external application according to various embodiments of the present disclosure;

FIGS. 11A and 11B are views illustrating a pop-up window that is provided instead of providing a UI according to various embodiments of the present disclosure;

FIG. 12 is a flowchart illustrating a method of controlling a display apparatus according to an embodiment of the present disclosure; and

FIG. 13 is a flowchart illustrating a method of controlling a display apparatus if a display item is a thumbnail item included in an image list according to an embodiment of the present disclosure.

Throughout the drawings, it should be noted that like reference numbers are used to depict the same or similar elements, features, and structures.

### DETAILED DESCRIPTION

The following description with reference to the accompanying drawings provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

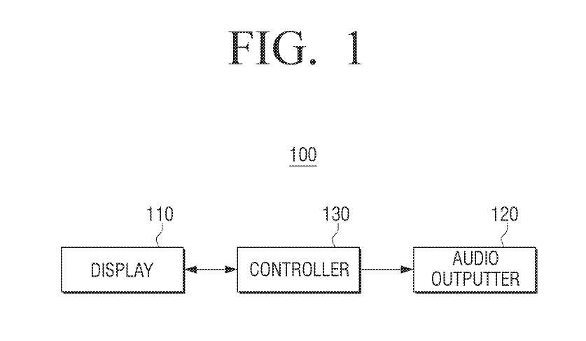

FIGS. 1 through 13, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a schematic block diagram illustrating a structure of a display apparatus according to an embodiment of the present disclosure.

Referring to FIG. 1, a display apparatus 100 is illustrated, where the display apparatus 100 includes a display 110, an audio outputter 120, and a controller 130. The display apparatus 100 may be realized as various types such as a tablet personal computer (PC), a smartphone, a smart television (TV), etc.

The display 110 displays a screen corresponding to an image signal received from various types of sources. In particular, the display 110 may display a display item and a user interface (UI) including at least one icon for controlling the display item. The display 110 may be designed as various types of display panels. In other words, the display 110 may be realized as various types of display technologies such as a liquid crystal display (LCD), an organic light-emitting diode (OLED), electronic paper (e-paper), a plasma display panel (PDP), a vacuum fluorescent display (VFD), a field emission display (FED), an electro luminescence display (ELD), etc.

The audio outputter 120 outputs an audio signal generated by an audio processor (not shown) or the like. The audio outputter 120 may be formed as an all-in-one type or a separated type with the display apparatus 100. If the audio outputter 120 is formed as the separated type, the audio outputter 120 is connected to the display apparatus 100 by wire or wireless. In particular, the audio outputter 120 may output audio corresponding to a display item included in a display screen. For example, the audio outputter 120 may output audio that reads a text displayed on the display screen.

The controller 130 controls overall elements of the display apparatus 100. In particular, the controller 130 controls the audio outputter 120 to analyze the display item included in the display screen of the display 110 so as to output audio corresponding to the display item. Also, when the audio is output, the controller 130 controls the display 110 to display a UI including at least one icon for controlling the display item corresponding to the output audio in an area of the display screen.

Also, if a user command for selecting an icon included in the displayed UI is input, the controller 130 performs a task of the display item mapped on the selected icon. For example, if the display item is a music item included in a music list, and audio corresponding to first one of a plurality of music items is output when the music list is displayed on the display screen, the controller 130 may control the display 110 to display the UI including an icon for executing music corresponding to the first music item in an area of the display screen.

As another example, if the display item is a thumbnail item included in an image list, and audio corresponding to first one of a plurality of thumbnail items is output when the image list is displayed on the display screen, the controller 130 may control the display 110 to display the UI, which includes at least one selected from an icon for executing an image corresponding to the first thumbnail item, an icon for editing the image corresponding to the first thumbnail item, and an icon for sharing the image corresponding to the first thumbnail item, in an area of the display screen.

As another example, if the display item is a slide bar item indicating a play time of an image content, and audio corresponding to the slide bar item is output when the image content is displayed on the display screen, the controller 130 may control the display 110 to display the UI including an icon for controlling the play time of the image content in an area of the display screen.

Also, if the display item is a hyperlink item, and audio corresponding to the hyperlink item is output, the controller 130 may control the display 110 to display the UI, which includes at least one selected from an icon for opening a webpage connected to a hyperlink, an icon for copying the hyperlink, and an icon for sharing a text including the hyperlink, in an area of the display screen.

As another example, if the display item is a text item including a text, and audio corresponding to the text item is output, the controller 130 may control the display 110 to display the UI, which includes at least one selected from an icon for selecting at least a part of the text included in the text item, an icon for copying the text included in the text item, and an icon for sharing the text included in the text item, in an area of the display screen.

The controller 130 may control the display 110 to display a text output as audio and an audio control icon for controlling an output state of the audio together in an area of the display screen. Also, if a user command for pausing audio output through an audio control icon is input, the controller 130 may control the display 110 to display a pop-up window including at least one icon around a display item corresponding audio output at an input time of the user command.

If a preset icon including the UI is selected, the controller 130 may control the display 110 to display a list including a plurality of icons for controlling a display item corresponding to audio output within a preset time.

Through the display apparatus 100 as described above, the user may intensively control only the UI displayed in an area of the display screen to perform a task performable on the display apparatus 100.

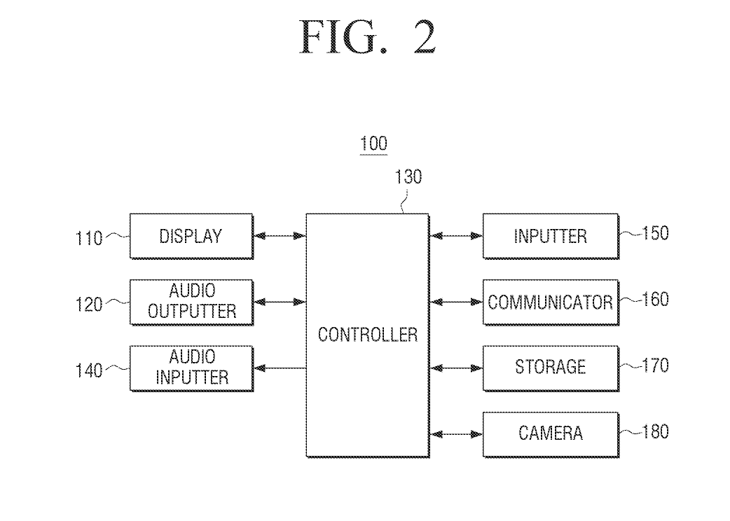

FIG. 2 is a block diagram illustrating a detailed structure of a display apparatus according to an embodiment of the present disclosure.

Referring to FIG. 2, a display apparatus 100 is illustrated, where the display apparatus 100 includes a display 110, an audio outputter 120, an audio inputter 140, an inputter 150, a communicator 160, a storage 170, a camera 180, and a controller 130.

The display 110 processes an image signal input from various types of sources to display a screen. The display 110 may display a UI, an application, a widget, etc. The display 110 may also display a display item and the UI including at least one icon for controlling the display item in an area of the screen.

The audio outputter 120 performs a function of outputting a voice signal. The audio outputter 120 may be realized as a speaker, a headphone output terminal, a Sony/Philips digital interface (S/PDIF) output terminal, or the like. For example, the audio outputter 120 may output audio corresponding to the display item.

The audio inputter 140 performs a function of inputting a voice signal. The audio inputter 140 receives a voice uttered by a user or an external voice signal and converts the voice or the external voice signal into an electric signal. Also, the electric signal may be converted into a digital signal and then transmitted to the controller 130. For example, if a voice signal corresponding to a control command for selecting an icon included in the UI is input through the audio inputter 140, a task mapped on the icon may be performed.

The inputter 150 performs a function of inputting a user command into the display apparatus 100. For example, the inputter 150 may be realized as a keypad, a touch screen, or the like. The inputter 150 may receive a user command through an input or the like for selecting an icon provided through the UI.

The communicator 160 performs a function of transmitting and receiving data or the like. The communicator 160 may be formed as a wireless or wire communication module to perform a wireless or wire communication function. For example, the communicator 160 may use various methods, such as a near field communication (NFC), a wireless local area network (WLAN), an infrared (IR) communication, a Zigbee communication, wireless fidelity (Wi-Fi), Bluetooth (BT), etc., as a wireless communication method.

The storage 170 stores various types of programs, modules, and data necessary for an operation of the display apparatus 100. The storage 170 may also store an application, etc. executed in the display apparatus 100. The storage 170 may include a random access memory (RAM) and a read only memory (ROM). As well known in the related field, the ROM operates to unidirectionally transmit data and a command to a central processing unit (CPU), and the RAM is used to bi-directionally transmit data and a command.

The camera 180 provides a picture capturing function and a moving picture capturing function. The camera 180 is an element for a still image or a moving image under control of the user and may include a plurality of cameras such as a front camera, a back camera, etc. In addition, the camera 180 may recognize a shape of a captured object and transmit the shape of the captured object to the controller 130. The controller 130 may analyze the shape of the object and transmit a corresponding control command to respective elements.

The controller 130 controls other elements of the display apparatus 100 such as the display 110, the audio outputter 120, the audio inputter 140, the inputter 150, the communicator 160, the storage 170, the camera 180, etc. The controller 130 may include a CPU, and an ROM and an RAM storing a module and data for controlling the display apparatus 100.

The controller 130 controls the audio outputter 120 to analyze a display item included in a display screen of the display 110 so as to output audio corresponding to the display item. The controller 130 also controls the display 110 to display the UI including at least one icon for controlling a display item corresponding to the output audio in an area of the display screen.

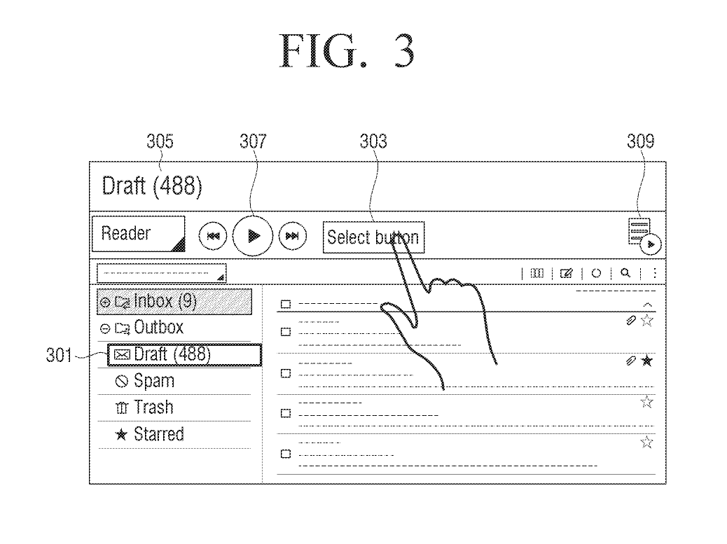

An operation of the controller 130 will now be described in detail with reference to FIGS. 3 through 11B.

FIG. 3 is a view illustrating a UI including at least one icon for controlling a display item according to an embodiment of the present disclosure.

Referring to FIG. 3, a display screen including a UI and a display item 301 is illustrated. According to an embodiment of the present disclosure, the controller 130, as illustrated in FIG. 2, controls the audio outputter 120, as illustrated in FIG. 2, to output audio corresponding to the display item 301 included in the display screen. For example, the controller 130 may analyze a text of the display item 301 to convert the text of the display item 301 into a voice signal. A function of reading a display screen element, such as a text-to-sound (TTS), a talk back, or the like, may be used.

The display item 301 is a screen element that is displayed on the display screen. If a performable task exists with a screen element, the controller 130 recognizes the corresponding screen element as a display item. For example, if a screen element that is a hyperlink is displayed on the display screen, the controller 130 may perform a task or the like for opening a webpage connected to the hyperlink. Therefore, the controller 130 recognizes the screen element, which is the hyperlink, as the display item.

The controller 130 may control the display 110, as illustrated in FIG. 2, to display the UI including an icon 303 for controlling the display item 301 in an area of the display screen. If a user command for selecting the icon 303 included in the displayed UI is input through the inputter 150, as illustrated in FIG. 2, the controller 130 performs a function of selecting a button, wherein the function is a task of a display item mapped on the selected icon 303.

An icon 303 is a virtual button on which a task performable by using a display item is mapped. For example, if a display item is a text item including a text, a task that is performable by using a text by the controller 130 may be a text selection, a text copy, a text share, or the like. The controller 130 controls the display 110 to display icons, on which tasks are respectively mapped, on the UI. The controller 130 may control the display 110 to display an icon, on which the words “Select text,” “Copy text,” and “Share text.” are written, on the UI. Here, a task is referred to as a term saying a performable function or the like. Not a single function but a plurality of functions that are sequentially performed may be a task.

The controller 130 may also control the display 110 to display a text 305, which is output as audio and an audio control icon 307, which is for controlling an audio output state, together in an area of the display screen. The controller 130 controls the display 110 to display the text 305 of a part output as audio on a part of the UI so as to enable the text 305 to be visually seen. When a screen element of the display screen is output as audio, the controller 130 controls an output state of the audio by using the audio control icon 307. For example, if icon “pause” is selected, the controller 130 may control the audio outputter 120 to pause the output of the audio.

The displayed UI may include a preset icon 309. If a user command for selecting the preset icon 309 is input into the inputter 150, the controller 130 may control the display 110 to display a list including a plurality of icons for controlling a display item corresponding to an audio output within a preset time. When an audio signal corresponding to the display item 301 is output, the controller 130 controls the display 110 to display the icon 303, on which a task of a display item is mapped, on a UI. However, when an audio signal corresponding to a next display item is output, an icon may be changed so as not to perform a task and to pass the task. The icon 303 that is displayed for a preset time is required to be left. For example, the controller 130 may control the display 110 to separately display an icon previously displayed in two lines on the UI, and an icon for controlling a display item corresponding to a currently output audio.

As another example, only if there is a user input for selecting the preset icon 309 included in the displayed UI, the controller 130 may control the display 110 to display a list including a plurality of icons for controlling a display item corresponding to audio output within a preset time. If the preset icon 309 is used, a ratio of the UI occupying a screen may be lowered.

According to an embodiment of the present disclosure, a display item may be a music item.

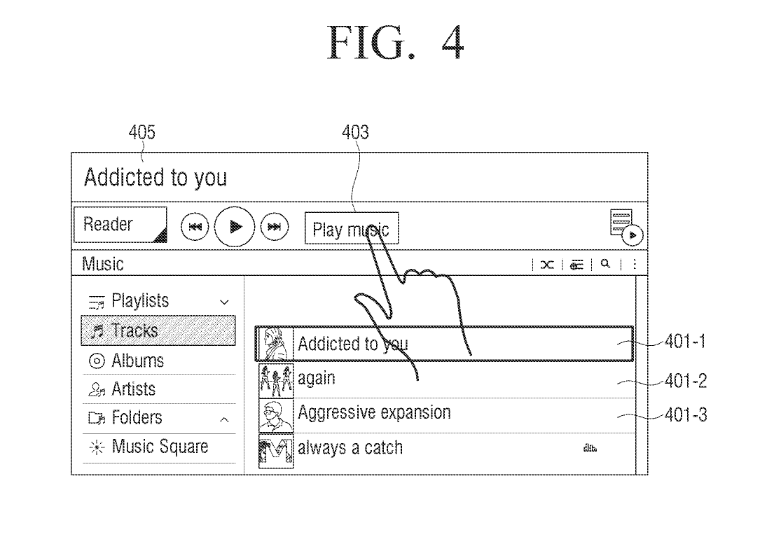

FIG. 4 is a view illustrating a display item that is a music item according to an embodiment of the present disclosure.

Referring to FIG. 4, a music application is illustrated, where the music application is executed on a display screen.

Specifically, a display item is a plurality of music items 401-1, 401-2, and 401-3 included in a music list. If audio corresponding to the first music item 401-1 of the plurality of music items 401-1, 401-2, and 401-3 is output when the music list is displayed on the display screen, the controller 130, as illustrated in FIG. 2, controls the display 110, as illustrated in FIG. 2, to display a UI including an icon for executing music corresponding to the first music item 401-1 in an area of the display screen. In addition, in response to audio being output, the controller 130 may control the display 110 to display a text of the first music item 401-1 on top of the UI. As another example, the controller 130 may control the display 110 to display an icon 403 for executing the music, an icon for downloading an mp3 file, an icon for providing music information such as song lyrics information or songwriter information, etc. on the UI. Also, the controller 130 controls the display 110 to display a text 405 of a part output as audio on a part of the UI so as to enable the text 405 to be visually seen. For example, if a tile of the first music item 401-1 is output as audio in FIG. 4, the controller 130 may control the display 110 to display the text 405 corresponding to the title of the first music item 401-1 on a part of the UI.

According to another embodiment of the present disclosure, a display item may be a thumbnail item included in an image list. If audio corresponding to first one of a plurality of thumbnail items is output through the audio outputter 120, as illustrated in FIG. 2, when the image list is displayed on a display screen, the controller 130 may control the display 110 to display the UI, which includes at least one selected from an icon for executing an image corresponding to the first thumbnail item, an icon for editing the image corresponding to the first thumbnail item, and an icon for sharing the image corresponding to the first thumbnail item, in an area of the display screen.

As another example, the controller 130 may control the display 110 to display an icon for providing play time information of the image corresponding to the first thumbnail item instead of displaying an icon for performing the above-described task. The controller 130 may control the display 110 to display an icon on which the above-described task and a modifiable task are mapped.

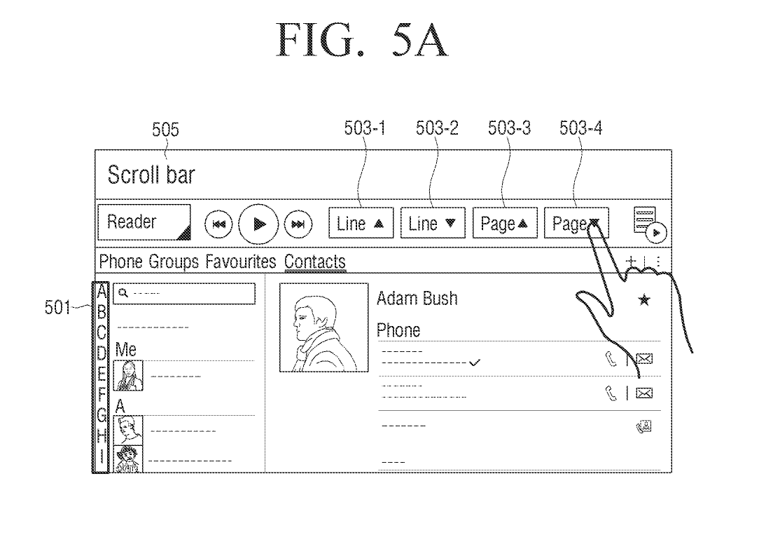

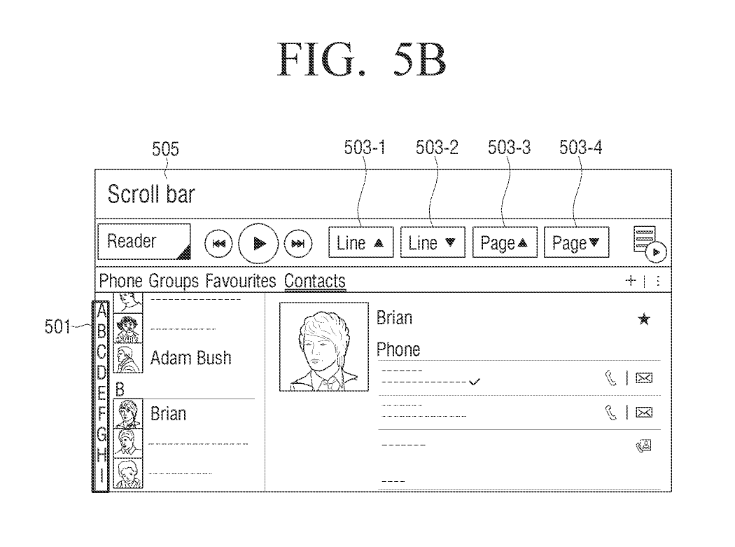

FIGS. 5A and 5B are views illustrating a display item that is a scroll bar item according to various embodiments of the present disclosure.

Referring to FIGS. 5A and 5B, a scroll bar item 501 is illustrated, such that if audio corresponding to the scroll bar item 501 is output, the controller 130, as illustrated in FIG. 2, controls the display 110, as illustrated in FIG. 2, to display a UI, which includes icons 503-1, 503-2, 503-3, and 503-4 for changing a position of a list by using a scroll bar, in an area of a display screen. As another example, when audio “A,” “B,” etc. included in the scroll bar item 501 is output, the controller 130 may control the display 110 to display a text 505 “Scroll Bar” instead of displaying texts “A,” “B,” etc. corresponding to the audio on a part of the UI. The controller 130 may also control the audio outputter 120, as illustrated in FIG. 2, to output audio “This part corresponds to a scroll bar,” together.

If the icon 503-4 for paging down is selected from displayed icons in FIG. 5A, the controller 130 performs a task for paging down a list and displaying information existing in a lower part of the list. If a task mapped on the icon 503-4 for paging down the page is performed, the controller 130 may control the display 110 to change a display screen as shown in FIG. 5B. For example, if a list of persons starting with “A” is displayed, and then the icon 503-4 for paging down is selected, a list of persons starting with “B” may be displayed. Also, as shown in FIG. 5A, the controller 130 controls the display 110 to display phone information, etc. of “Adam Bush” in a center of the display screen in response to the change in the list. However, as shown in FIG. 5B, the controller 130 may control the display 110 to display phone information, etc. of “Brian” in the center of the display screen.

According to an embodiment of the present disclosure, a display item may be a slide bar item indicating a play time of an image content.

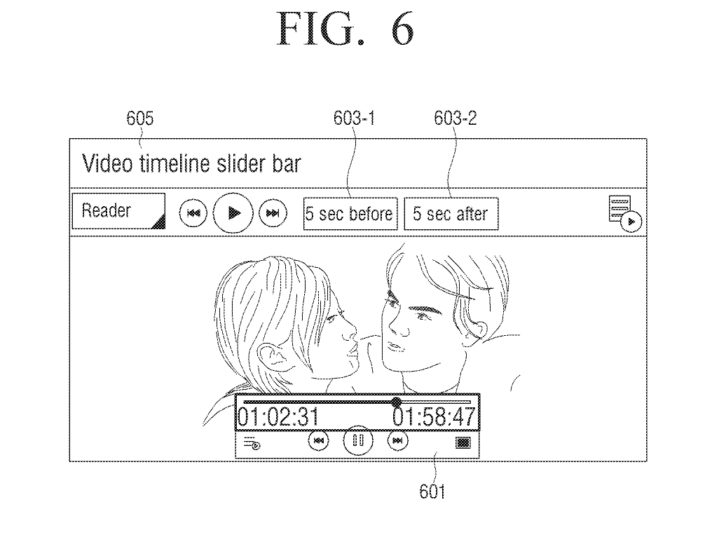

FIG. 6 is a view illustrating a display item that is a slide bar item according to an embodiment of the present disclosure.

Referring to FIG. 6, a slide bar item 601 is illustrated, such that if audio corresponding to the slide bar item 601 is output when an image content is displayed on a display screen, the controller 130, as illustrated in FIG. 2, may control the display 110, as illustrated in FIG. 2, to display a UI including icons 603-1 and 603-2 for controlling a play time of the image content in an area of the display screen. As to a display item that is not expressed as a text like the slide bar item 601, the controller 130 may control the audio outputter 120, as illustrated in FIG. 2, to output audio corresponding to a name of the display item.

For example, as to the slide bar item 601 of FIG. 6, the controller 130 may control the audio outputter 120 to output audio such as “Slide bar,” “Video timeline slide bar,” and/or “This part corresponds to a slide bar.” The controller 130 may also control the display 110 to display a text 605 “Video timeline slide bar” in an area of the UI in response to an audio output.

According to an embodiment of the present disclosure, a display item may be a text item including a text.

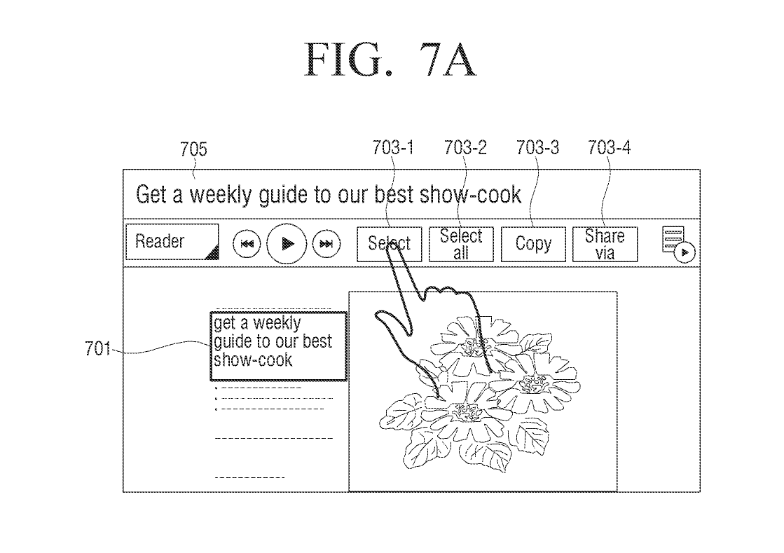

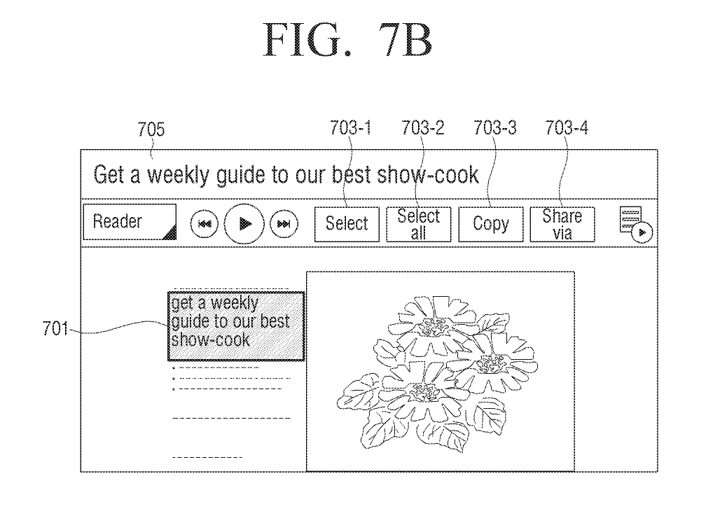

FIGS. 7A and 7B are views illustrating a display item that is a text item according to various embodiments of the present disclosure.

Referring to FIGS. 7A and 7B, a text item 701 is illustrated, such that if audio corresponding to the text item 701 is output, the controller 130, as illustrated in FIG. 2, may control the display 110, as illustrated in FIG. 2, to display a UI, which includes at least one selected from icons 703-1 and 703-2 for selecting at least a part of a text included in the text item 701, an icon 703-3 for copying the text included in the text item 701, and an icon 703-4 for sharing the text included in the text item 701, in an area of a display screen. For example, if the icon 703-1 for selecting a part of the text included in the text item 701 is expressed with “Select” and selected in FIG. 7A, the controller 130 selects a corresponding text part as shown in FIG. 7B. For example, the controller 130 may control the display 110 to shade and display the selected text so as to enable the selected text to be distinguished from other unselected texts. As another example, if the icon 703-4 for sharing the text is selected, the controller 130 may control the display 110 to copy the corresponding text and display a list for selecting an application to be used for sharing the copied text. The controller 130 may also control the display 110 to display a text 705 output as audio in an area of the UI in response to audio that corresponds to the text item 701 and is output.

According to an embodiment of the present disclosure, a display item may be a hyperlink item.

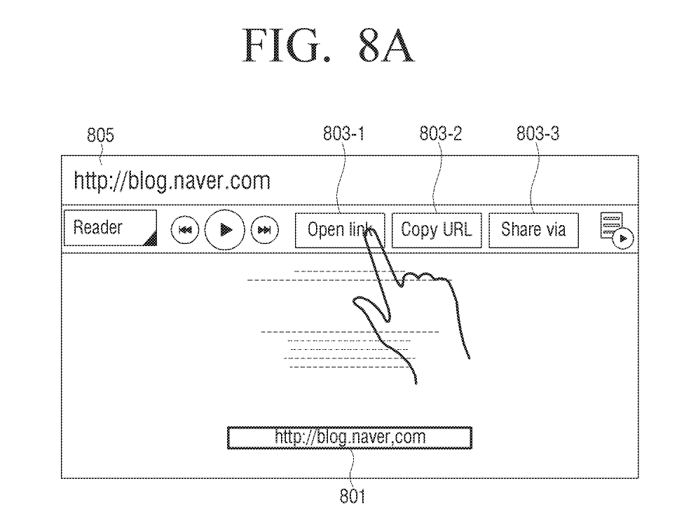

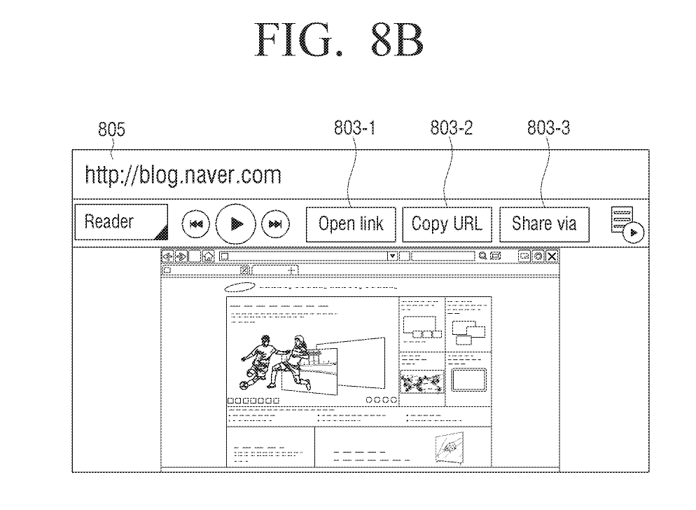

FIGS. 8A and 8B are views illustrating a display item that is a hyperlink item according to various embodiment of the present disclosure.

Referring to FIGS. 8A and 8B, a hyperlink item 801 is illustrated, such that if audio corresponding to the hyperlink item 801 is output, the controller 130, as illustrated in FIG. 2, may control the display 110, as illustrated in FIG. 2, to display a UI, which includes at least one selected from an icon 803-1 for opening a webpage connected to the hyperlink 801, an icon 803-2 for copying the hyperlink 801, and an icon 803-3 for sharing a text including the hyperlink 801, in an area of a display screen. For example, if a link included in the hyperlink is “http://blog.naver.com,” and the icon 803-1 for opening the webpage connected to the hyperlink is selected, the controller 130 opens a webpage corresponding to “http://blog.naver.com” as shown in FIG. 8B. The controller 130 may also control the display 110 to display a text 805 corresponding to audio output in an area of the display screen. In FIGS. 8A and 8B, the text 805 corresponding to the output audio may be “http://blog.naver.com” that is the same as a text of the hyperlink 801.

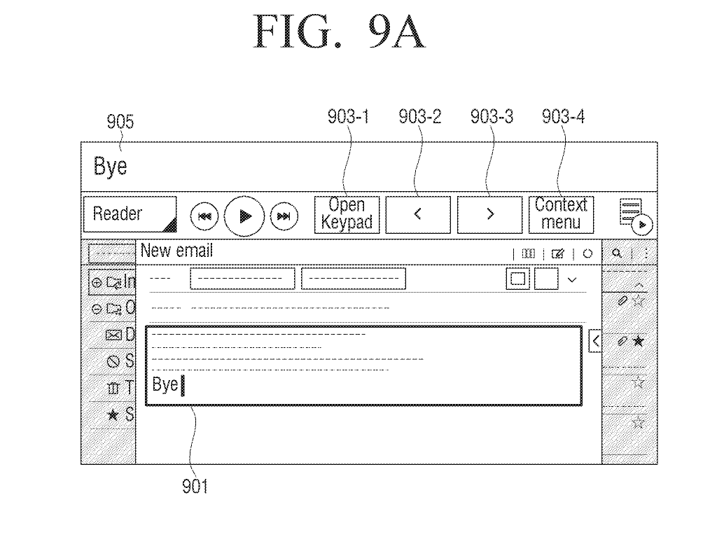

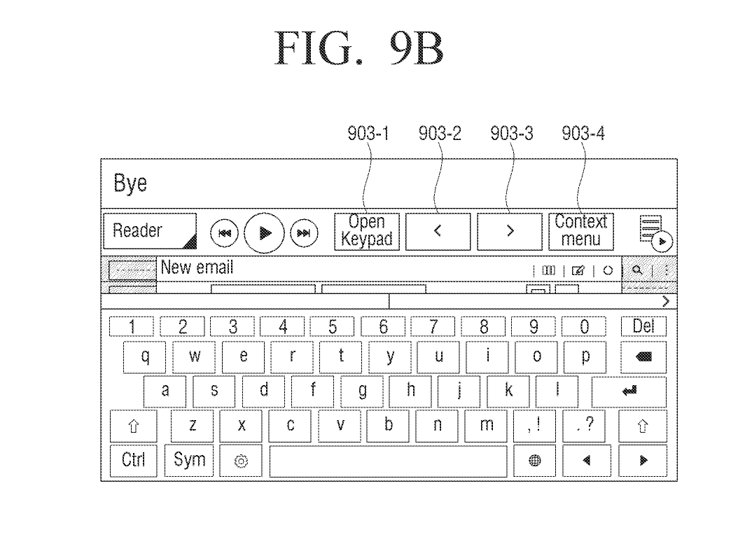

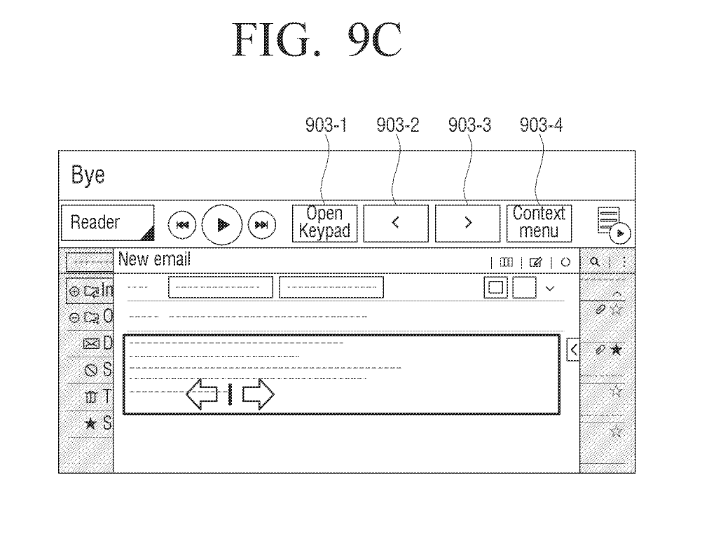

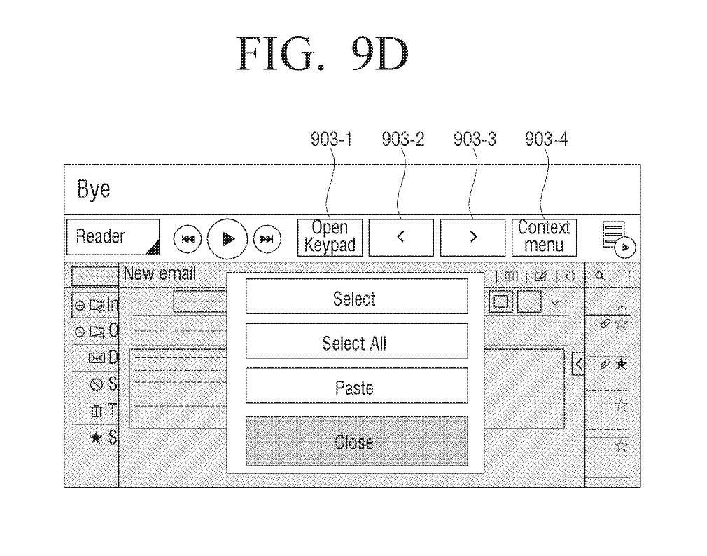

FIGS. 9A through 9D are views illustrating a display item that is a text input item according to various embodiments of the present disclosure.

Referring to FIG. 9A, a text input item 901 is illustrated, such that if a display item is the text input item 901, the controller 130, as illustrated in FIG. 2, may control the audio outputter 120, as illustrated in FIG. 2, to output audio corresponding to the text input item 901. For example, the audio corresponding to the text input item 901 may be audio corresponding to a lastly input text, audio “A text may be input into this part,” or the like. If the audio corresponding to the lastly input text is output, the controller 130 may control the display 110, as illustrated in FIG. 2, to display a text 905 “Bye” that is lastly input in an area of a UI.

As another example, the controller 130 may control the display 110 to set a text “Text Input” indicating the text input item 901 to a text corresponding to audio and display the text in an area of the UI. If the audio corresponding to the text input item 901 is output, the controller 130 may control the display 110 to display the UI, which includes at least one selected from an icon 903-1 for opening a keypad for inputting a text, icons 903-2 and 903-3 for moving a cursor for controlling a text input position, and an icon 903-4 for opening a menu associated with a text input, in an area of a display screen.

Referring to FIGS. 9B to 9D, icons 903-1, 903-2, 903-3 and 903-4 are illustrated. For example, if the icon 903-1 for opening the keypad for inputting the text is selected, the controller 130 controls the display 110 to display the keypad on the display screen as shown in FIG. 9B. If a user interaction is input on the displayed keypad, the controller 130 inputs a corresponding letter key. As another example, if the icons 903-2 and 903-3 for moving the cursor for controlling the text input position are selected, the controller 130 may control the cursor to be move as shown in FIG. 9C. If the icon 903-1 for opening the keypad is re-selected after the cursor is moved, the controller 130 may input letters into a position into which the cursor is moved. As another example, if the icon 903-4 for opening the menu associated with the text input is selected, the controller 130 may control the display 110 to display a menu including an icon for performing a task of selecting or pasting a text as shown in FIG. 9D.

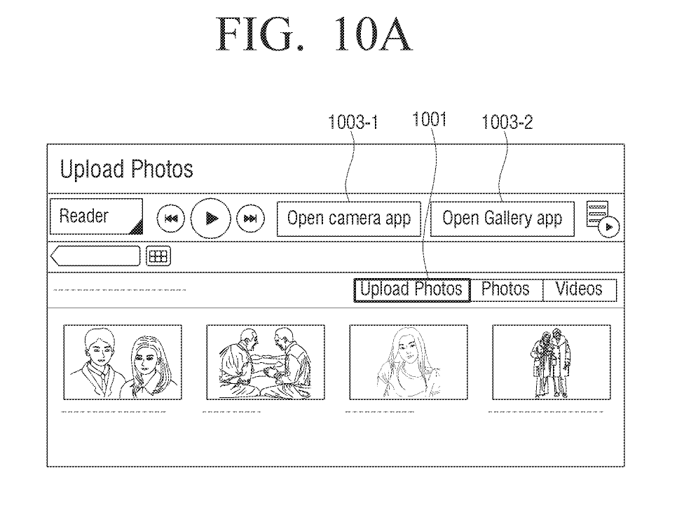

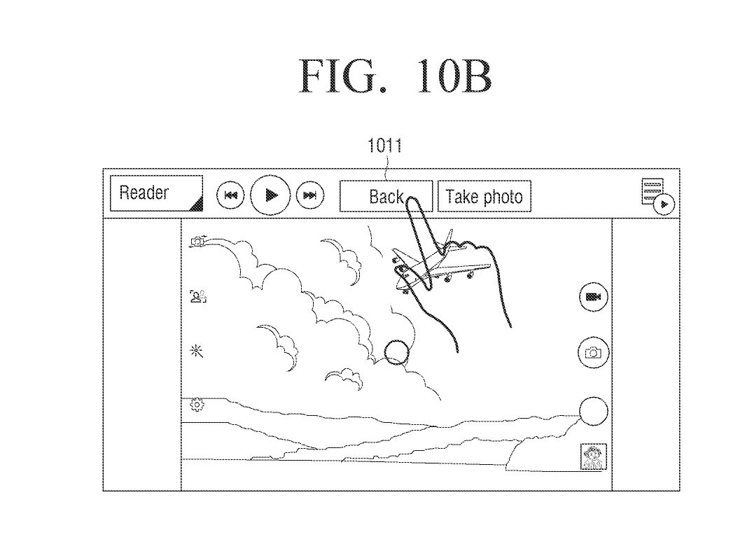

FIGS. 10A and 10B are views illustrating a task that is executed through an external application according to various embodiments of the present disclosure.

Referring to FIG. 10A, a photo upload item 1001 is illustrated, where the photo upload item 1001 is a display item and preview images of a photo are displayed on a display screen. If audio corresponding to the photo upload item 1001 is output, the controller 130, as illustrated in FIG. 2, may control the display 110, as illustrated in FIG. 2, to display a UI, which includes at least one selected from an icon 1003-1 for executing a camera application to select a photo to be uploaded and an icon 1003-3 for executing a gallery application to select a photo to be uploaded, in an area of the display screen. If the icon 1003-1 for executing the camera application to select the photo to be uploaded is selected, the controller 130 executes an external camera application as shown in FIG. 10B. If an external application is executed, a display apparatus may not return to an original display screen, which causes an inconvenience to a user. For example, if the external application is executed, the controller 130 may control the display 110 to display the UI including an icon 1011 for returning to an original display screen in an area of the display screen.

According to another embodiment of the present disclosure, instead of displaying a UI including at least one icon for controlling a display item, the controller 130 may control the display 110 to display the at least one icon for controlling the display item around the display item in response to a user command that is input to pause an audio output. For example, the user command for pausing the audio output may be input through an audio control icon included in the UI. As another example, a user input for pausing an audio output may be a user interaction for tapping a screen.

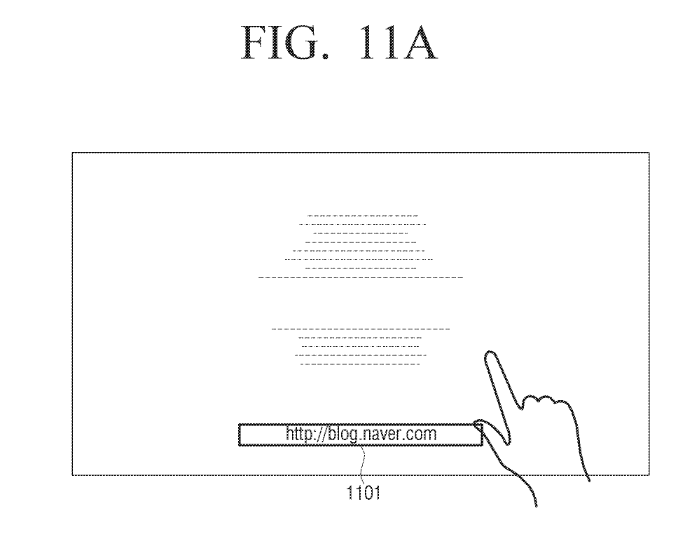

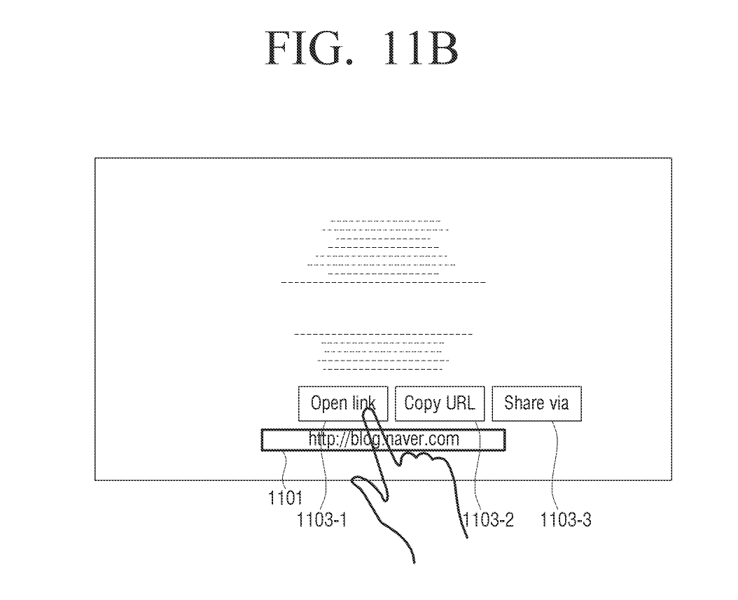

FIGS. 11A and 11B are views illustrating a pop-up window that is provided instead of providing a UI according to various embodiments of the present disclosure.

Referring to FIG. 11A, a display item 1101 is illustrated, such that if a user interaction for tapping a screen is input when audio corresponding to the display item 1101 that is a hyperlink item is output, the controller 130, as illustrated in FIG. 2, controls the audio outputter 120, as illustrated in FIG. 2, to pause an audio output. Also, as shown in FIG. 11B, the controller 130 may control the display 110, as illustrated in FIG. 2, to display a pop-up window including at least one of icons 1103-1, 1103-2, and 1103-3 around the display item 1101 corresponding to an audio output at an input time of the user interaction.

Besides kinds of display items described in the above-described embodiments of the present disclosure, icons, etc. of a display screen may be display items. A UI, including icons on which tasks of performing a left side click, a double click, and a right click with respect to the icons of the display screen, may be displayed. As described above, the spirit of the present disclosure is not limited to the above-described embodiments and may include modifications that may be easily realized by those skilled in the art.

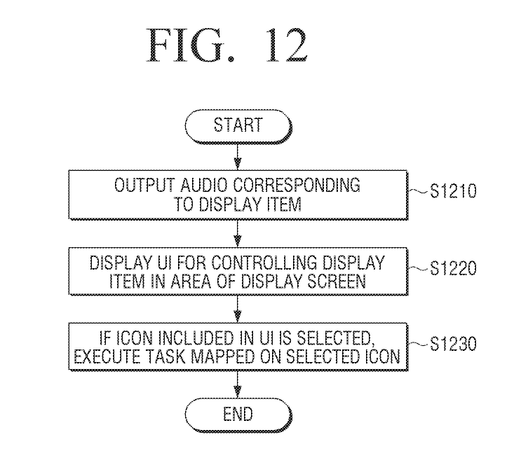

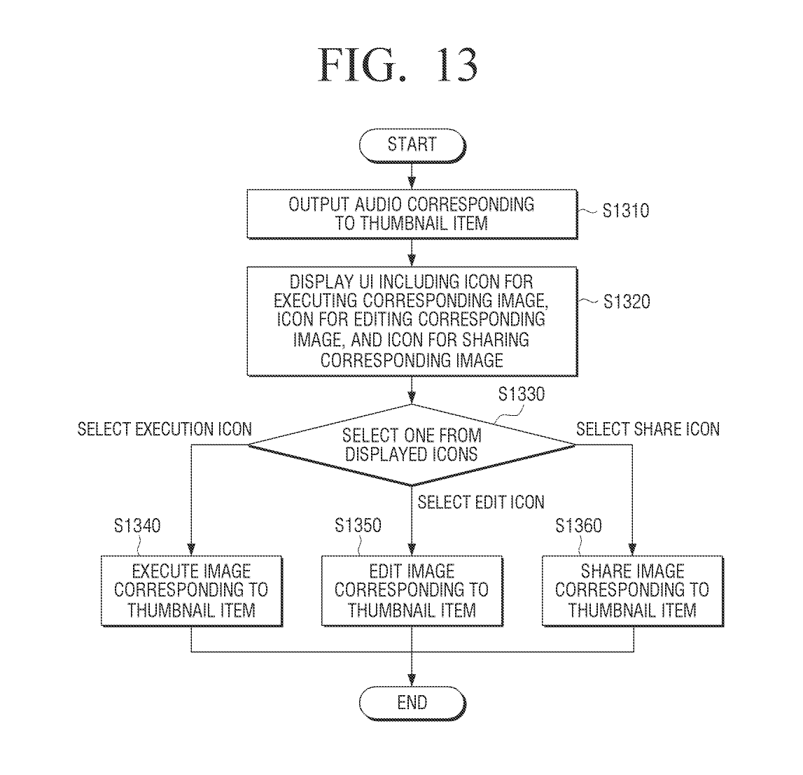

Methods of controlling the display apparatus 100, as illustrated in FIG. 2, will now be described with reference to FIGS. 12 through 13.

FIG. 12 is a flowchart illustrating a method of controlling a display apparatus according to an embodiment of the disclosure.

Referring to FIG. 12, in operation S1210, the display apparatus 100, as illustrated in FIG. 2, analyzes a display item included in a display screen to output audio corresponding to the display item. Operation S 1210 may be realized through a function such as a TTS or a talk back.

When the audio is output, the display apparatus 100 displays a UI, which includes at least one icon including at least one item for controlling the display item corresponding to the output audio, in an area of the display screen in operation S1220. Here, the display apparatus 100 may display a text output as audio and an audio control icon for controlling an output state of the audio along with the UI in an area of the display screen or may display the audio control icon including the UI in the area of the display screen. The display apparatus 100 may include a preset icon for re-displaying an icon, which is displayed and then disappears within a preset time, in the UI.

If the preset icon included in the UI is selected, the display apparatus 100 may display a list including a plurality of icons for controlling a display item corresponding to an audio output within a preset time. If a user command for selecting an icon included in the displayed UI is input, the display apparatus 100 performs a task of a display item mapped on the selected icon in operation S1230.

For example, if a display item is a music item included in a music list, the display apparatus 100 may output audio corresponding to first one of a plurality of music items when the music list is displayed on the display screen. Also, the display apparatus 100 may display the UI including an icon for executing music corresponding to the first music item in an area of the display screen. If an icon is selected, the display apparatus 100 performs an operation of executing the first music item that is a task mapped on the icon.

As another example, if a display item is a hyperlink item, the display apparatus 100 outputs audio corresponding to the hyperlink item. Also, the display apparatus 100 displays the UI, which includes at least one selected from an icon for opening a webpage connected to a hyperlink, an icon for copying the hyperlink, and an icon for sharing a text including the hyperlink, in an area of the display screen.

As another example, if a display item is a slide bar item indicating a play time of an image content, the display apparatus 100 outputs audio corresponding the slide bar item when the image content is displayed on the display screen. The display apparatus 100 displays the UI including an icon for controlling a play time of the image content in an area of the display screen.

FIG. 13 is a flowchart illustrating a method of controlling a display apparatus if a display item is a thumbnail item included in an image list according to an embodiment of the present disclosure.

Referring to FIG. 13, when an image list is displayed on a display screen, the display apparatus 100, as illustrated in FIG. 2, outputs audio corresponding to first one of a plurality of thumbnail items in operation S1310.

In operation S1320, the display apparatus 100 displays a UI, which includes at least one selected from an icon for executing an image corresponding to the first thumbnail item, an icon for editing the image corresponding to the first thumbnail item, and an icon for sharing the image corresponding to the first thumbnail item, in an area of the display screen.

If a user command for selecting one of a plurality of icons included in the displayed UI is input in operation S1330, the display apparatus 100 performs a task of a display item mapped on the selected icon. If an execution icon is selected, the display apparatus 100 performs a task of executing the image corresponding to the first thumbnail item, i.e., a mapped task, in operation S1340.

As another example, if an edit icon is selected, the display apparatus 100 performs a task of editing the image corresponding to the first thumbnail item, i.e., a mapped task, in operation S1350.

If a share icon is selected, the display apparatus 100 performs a task of sharing the image corresponding to the first thumbnail item, i.e., a mapped task, in operation S1360.

As another example, if a display item is a text item including a text, the display apparatus 100 outputs audio corresponding to the text item. Also, the display apparatus 100 may display a UI, which includes at least one selected from an icon for selecting at least a part of the text included in the text item, an icon for copying the text included in the text item, and an icon for sharing the text included in the text item, in an area of the display screen. If a user command for selecting one of a plurality of icons included in the displayed UI is input, the display apparatus 100 performs a task of a display item mapped on the selected icon.

According to various embodiments of the present disclosure as described above, a user may recognize elements on a display screen through audio and may also know about a performable task through a UI.

A program code for performing controlling methods according to various embodiments of the disclosure as described above may be stored on various types of recording media. In detail, the program code may be stored on various types of recording media such as an RAM, a flash memory, an ROM, an erasable programmable ROM (EPROM), an electronically erasable and programmable ROM (EEPROM), a register, a hard disc, a removable disc, a memory card, a universal serial bus (USB) memory, a Compact Disk-ROM (CD-ROM), etc.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or ore non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling a display apparatus, the method comprising:
analyzing a display item displayed on a display screen;
outputting audio corresponding to the analyzed display item; and
in response to the audio being output, displaying a user interface (UI), which comprises at least one icon for controlling the display item corresponding to the output audio, in an area of the display screen.

2. The method of claim 1, further comprising:
in response to a user command being input to select an icon displayed on the displayed UI, performing a task of the display item mapped to the selected icon.

3. The method of claim 1, wherein the displaying of the UI comprises:
displaying a text output as the audio and an audio control icon for controlling an output state of the audio together in the area of the display screen.

4. The method of claim 3, wherein the displaying of the UI further comprises:
in response to a user command being input to pause the output of the audio through the audio control icon, displaying a pop-up window comprising at least one icon around a display item corresponding to audio output at an input time of the user command.

5. The method of claim 1, wherein the displaying of the UI comprises:
in response to a preset icon displayed on the UI being selected, displaying a list comprising a plurality of icons for controlling a display item corresponding to audio output within a preset time.

6. The method of claim 1,
wherein the display item is a music item comprised in a music list, and
wherein the displaying of the UI comprises, in response to the music list being displayed on the display screen and audio, corresponding to a first music item of a plurality of music items, being output:
displaying the UI comprising an icon for executing music corresponding to the first music item in the area of the display screen.

7. The method of claim 1,
wherein the display item is a thumbnail item comprised in an image list, and
wherein the displaying of the UI comprises, in response to the image list being displayed on the display screen and audio, corresponding to a first thumbnail item of a plurality of thumbnail items, being output:
displaying the UI, which comprises at least one selected from an icon for executing an image corresponding to the first thumbnail item, an icon for editing the image corresponding to the first thumbnail item, and an icon for sharing the image corresponding to the first thumbnail item, in the area of the display screen.

8. The method of claim 1,
wherein the display item is a slide bar item indicating a play time of an image content, and
wherein the displaying of the UI comprises, in response to the image content being displayed on the display screen and audio, corresponding to the slide bar item, being output:
displaying the UI, which comprises an icon for controlling the play time of the image content, in the area of the display screen.

9. The method of claim 1,
wherein the display item is a hyperlink item, and
wherein the displaying of the UI comprises, in response to audio, corresponding to the hyperlink item, being output:
displaying the UI, which comprises at least one selected from an icon for opening a webpage connected to a hyperlink, an icon for copying the hyperlink, and an icon for sharing a text comprising the hyperlink, in the area of the display screen.

10. The method of claim 1,
wherein the display item is a text item comprising a text, and
wherein the displaying of the UI comprises, in response to audio corresponding to the text item, being output:
displaying the UI, which comprises at least one selected from an icon for selecting at least a part of the text comprised in the text item, an icon for copying the text comprised in the text item, and an icon for sharing the text comprised in the text item, in the area of the display screen.

11. A display apparatus comprising:
a display;
an audio outputter configured to output an audio signal; and
a controller configured to:
control the audio outputter to analyze a display item displayed on a display screen of the display,
control the audio outputter to output the audio corresponding to the analyzed display item, and
control the display to, in response to the audio being output, display a user interface (UI) comprising at least one icon for controlling the display item corresponding to the output audio in an area of the display screen.

12. The display apparatus of claim 11, further comprising:
an inputter configured to receive a user command,
wherein, in response to the user command being input through the inputter to select an icon displayed on the displayed UI, the controller is further configured to perform a task of the display item mapped to the selected icon.

13. The display apparatus of claim 11, wherein the controller is further configured to control the display to display a text output as the audio and an audio control icon for controlling an output state of the audio together in the area of the display screen.

14. The display apparatus of claim 13, further comprising:
an inputter configured to receive a user command,
wherein, in response to the user command being input through the inputter to pause the output of the audio through the audio control icon, the controller is further configured to control the display to display a pop-up window comprising at least one icon around a display item corresponding to audio output at an input time of the user command.

15. The display apparatus of claim 11, further comprising:
an inputter configured to receive a user command,
wherein, in response to a preset icon displayed on the UI being selected through the inputter, the controller is further configured to control the display to display a list comprising a plurality of icons for controlling a display item corresponding to audio output within a preset time.

16. The display apparatus of claim 11,
wherein the display item is a music item comprised in a music list, and
wherein in response to the music list being displayed on the display screen and audio, corresponding to a first music item of a plurality of music items, being output, the controller is further configured to control the display to display the UI comprising an icon for executing music corresponding to the first music item in the area of the display screen.

17. The display apparatus of claim 11,
wherein the display item is a thumbnail item comprised in an image list, and
wherein, in response to the image list being displayed on the display screen and audio, corresponding to a first thumbnail item of a plurality of thumbnail items, being output, the controller is further configured to control the display to display the UI, which comprises at least one selected from an icon for executing an image corresponding to the first thumbnail item, an icon for editing the image corresponding to the first thumbnail item, and an icon for sharing the image corresponding to the first thumbnail item, in the area of the display screen.

18. The display apparatus of claim 11,
wherein the display item is a slide bar item indicating a play time of an image content, and
wherein, in response to the image content being displayed on the display screen and audio, corresponding to the slide bar item, being output, the controller is further configured to control the display to display the UI comprising an icon for controlling the play time of the image content in the area of the display screen.

19. The display apparatus of claim 11,
wherein the display item is a hyperlink item, and
wherein, in response to audio, corresponding to the hyperlink item, being output, the controller is further configured to control the display to display the UI, which comprises at least one selected for an icon for opening a webpage connected to a hyperlink, an icon for copying the hyperlink, and an icon for sharing a text comprising the hyperlink, in the area of the display screen.

20. The display apparatus of claim 11,
wherein the display item is a text item comprising a text, and
wherein, in response to audio, corresponding to the text item, being output, the controller is further configured to control the display to display the UI, which comprises at least one selected from an icon for selecting at least a part of the text comprised in the text item, an icon for copying the text comprised in the text item, and an icon for sharing the text comprised in the text item, in the area of the display screen.
